(19) United States
(12) Patent Application Publication
(10) Pub. No.: US 2010/0127029 A1
(43) Pub. Date: May 27, 2010

(54) Structure of a removable carrier of a two-wheeled vehicle with stealth-proof function

(76) Inventor: Kuo-Jen Lee, Tainan City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 12/292,776

(22) Filed: Nov. 26, 2008

(51) Int. Cl. B62J 7/08; B62J 7/04

(52) U.S. Cl. 224/418; 211/86.01

(57) ABSTRACT

A removable carrier of a two-wheeled vehicle includes a supporting member, and a lock; the supporting member has several hooked hanging parts on each of two lateral sides of its upper end, and two lateral stopping parts; each of the hooked hanging parts has a tubular holding part joined on its outward end; the supporting member has a propping component on an upper portion, which is under the hooked hanging parts, and which has front and rear hanging parts protruding therefrom; the lock includes a lock body, and an U-shaped locking rod; in use, a bag is hung on the hooked hanging parts at its carry handles, and propped against the lateral supporting parts, and the lock is joined on the supporting member with the U-shaped locking rod being passed through the tubular holding parts and fixedly joined to the lock body, thus protecting the bag against theft.

### BACKGROUND OF THE INVENTION

1. Field of the invention

The present invention relates to a structure of a removable carrier of a two-wheeled vehicle with stealth-proof function, more particularly one, which allows bags such as briefcases and carry-on bags to be hung thereon and protected against theft with a lock joined on the carrier.

2. Brief Description of the Prior Art

Taiwan Patent Registration No. M275671 taught a combination structure of a removable carrier and a lock of a two-wheeled vehicle. The removable carrier and lock combination includes a supporting frame, propping components, two saddle-like bags, a circular lock, and a hard U-shaped rod; the propping components are used to support rectangular bags; a rectangular member is joined on the supporting frame; pipes are positioned between hard inner and outer half tubes; the saddle-like bags have carry handles consisting of hard tubes; the rectangular bags have hard linings, and hard outer pipes; the rectangular bags and the saddle-like bags are fastened to the carrier by means of the circular lock and the hard U-shaped rod.

The above structure is found to have the following drawbacks:

1. The carrier and lock combination can only be used to protect such saddle-like bags and such rectangular bags against theft, not capable of being used with common bags such as briefcases and carry-on bags. Therefore, the carrier and lock combination isn't convenient to use.

2. The carrier and lock combination has to include hard inner and outer half tubes, which are positioned on two sides of the pipes to support the handles of the saddle-like bags and hard outer pipes of the rectangular bags. Therefore, it has a relatively complicated structure, and high manufacturing cost.

3. In use, the hard U-shaped rod isn't fixed in position. Therefore, the U-shaped rod can hit against the rectangular member to produce noise and cause damage to the rectangular member when the vehicle is moving.

Therefore, it is a main object of the present invention to provide an improvement on a carrier of a two-wheeled vehicle to overcome the above problems.

### SUMMARY OF THE INVENTION

A carrier in accordance with an embodiment of the present invention includes a supporting member, and a lock. The supporting member has several hooked hanging parts on each of two lateral sides of its upper end, and two lateral stopping parts to prevent a wheel of the vehicle from getting entangled with a bag supported on the carrier. Each of the hooked hanging parts has a tubular holding part joined on its outward end. The supporting member has a propping component, which is under the hooked hanging parts, and which has front and rear hanging parts protruding from it. The lock includes a lock body, and an U-shaped locking rod. In use, a bag is hung on the hooked hanging parts at its carry handles, and propped against the lateral supporting parts, and the lock is joined on the supporting member with the U-shaped locking rod being passed through the tubular holding parts and fixedly joined to the lock body, thus protecting the bag against stealth.

### BRIEF DESCRIPTION OF THE DRAWINGS

The present invention will be better understood by referring to the accompanying drawings, wherein:

FIG. 1 is an exploded perspective view of the present invention,

FIG. 2 is a perspective view of the present invention,

FIG. 3 is a perspective view of the present invention in use (1),

FIG. 4 is a perspective view of the present invention in use (2),

FIG. 5 is a perspective view of the present invention in use (3),

FIG. 6 is a perspective view of the present invention in use (4),

FIG. 7 is a perspective view of the present invention in use (5),

FIG. 8 is a perspective view of the present invention in use (6),

FIG. 9 is a perspective view of the present invention in use (7), and

FIG. 10 is a perspective view of the present invention in use (8).

### DETAILED DESCRIPTION OF THE PREFERRED EMBODIMENTS

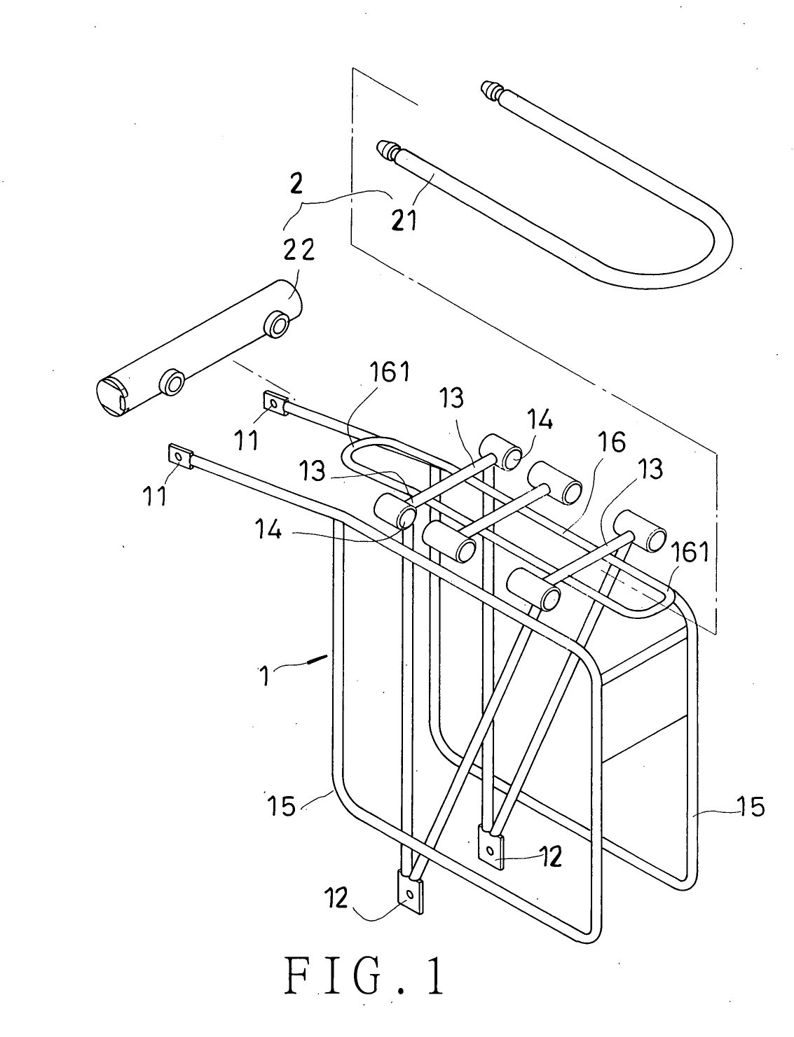

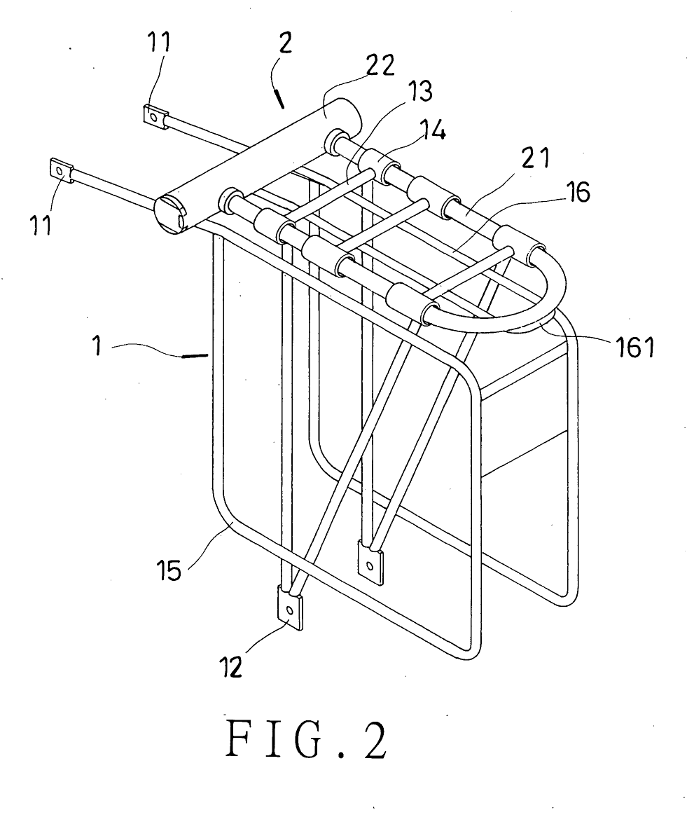

Referring to FIGS. 1 and 2, a preferred embodiment of a removable carrier of a two-wheeled vehicle with stealth-proof function in the present invention consists of a supporting member 1, and a lock 2.

The supporting member 1 has two front joining components 11 protruding from a front end thereof, which are fixedly joined to a body of a two-wheeled vehicle. The supporting member 1 has two lower joining components 12 protruding from lower ends of two lateral sides thereof, which are fixedly joined to a rear axle of the two-wheeled vehicle. The supporting member 1 has several hooked hanging parts 13 on each of two lateral sides of an upper end thereof. Each of the hooked hanging parts 13 has a tubular holding part 14 joined on an outward end thereof. The supporting member 1 has a stopping part 15 on each of two lateral sides thereof so that the lower joining components 12 exist between both of the stopping parts 15. Furthermore, the supporting member 1 has a propping component 16 on an upper portion thereof, which is under the hooked hanging parts 13; the propping component 16 has two hanging parts 161, which protrude from front and rear ends of the propping component 16 respectively.

The lock 2 includes a lock body 22, and a U-shaped locking rod 21; in use, the lock 2 is joined on the supporting member 1 with the U-shaped locking rod 21 being passed through the tubular holding parts 14 of the supporting member 1 and fixedly joined to the lock body 22.

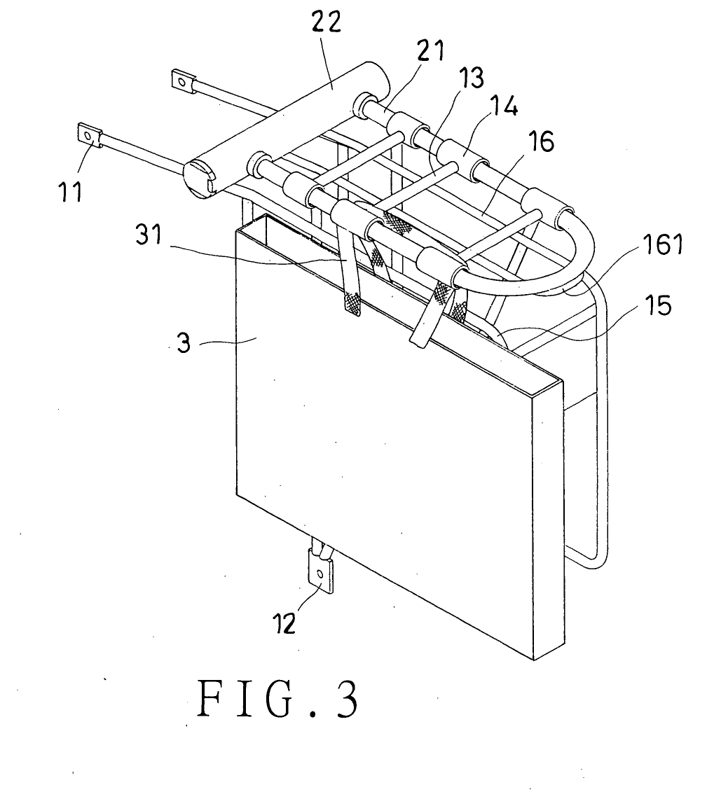

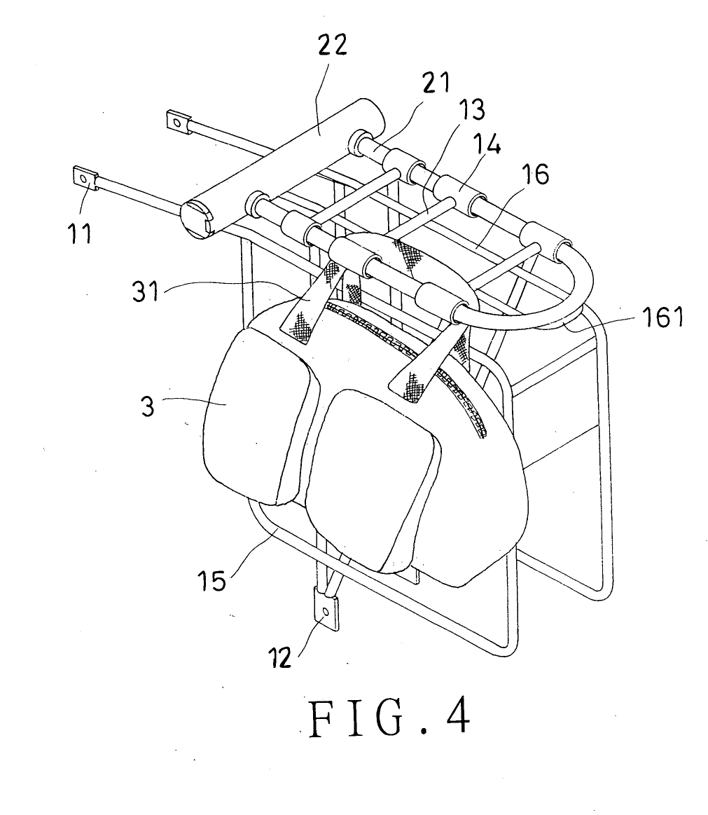

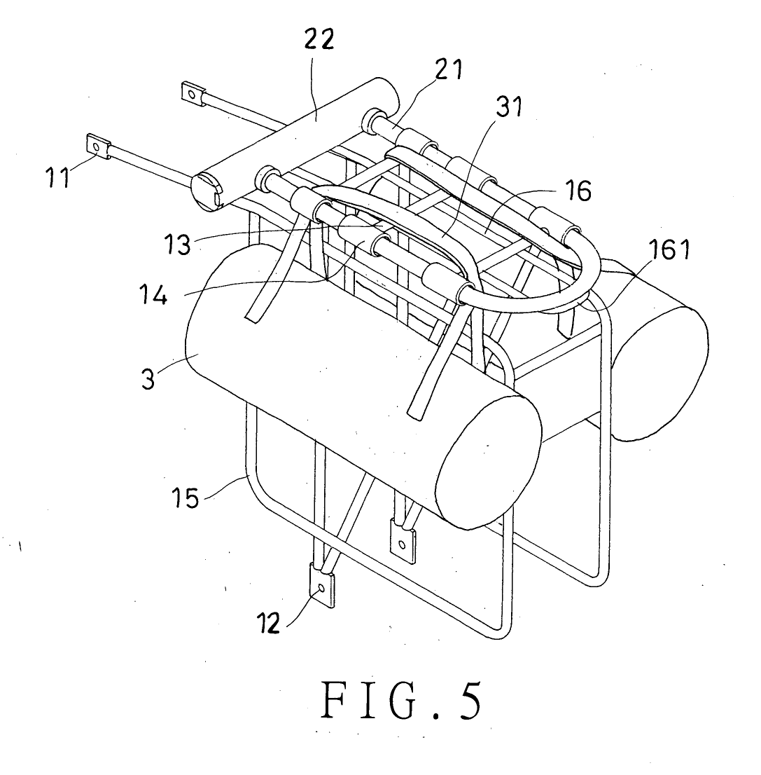

FIGS. 3 to 5 show a way to use the carrier of the present invention to support a bag 3 with short carry handles 31, e.g. carry-on bag and briefcase; the bag 3 is hung on the hooked hanging parts 13 on one side of the supporting member 1 at the carry handles 31 thereof. In addition, two bags 3 can be hung on the hooked hanging parts 13 on two sides of the supporting member 1 at the same time, as shown in FIG. 5. Next, the U-shaped locking rod 21 of the lock 2 is passed through the tubular holding parts 14, and the lock body 22 is fixedly joined on two free ends of the locking rod 21; thus, the bags 3 can be taken away from the carrier.

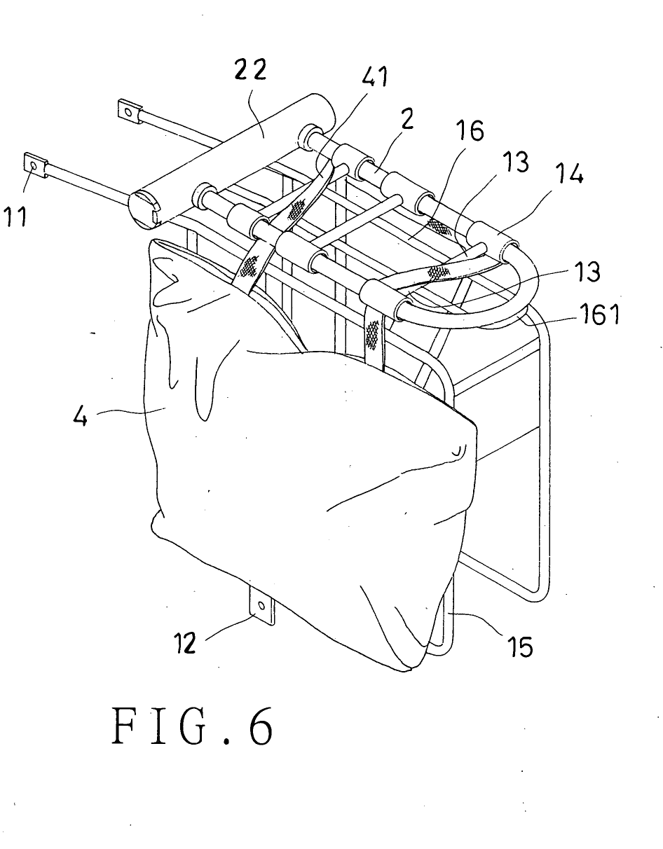

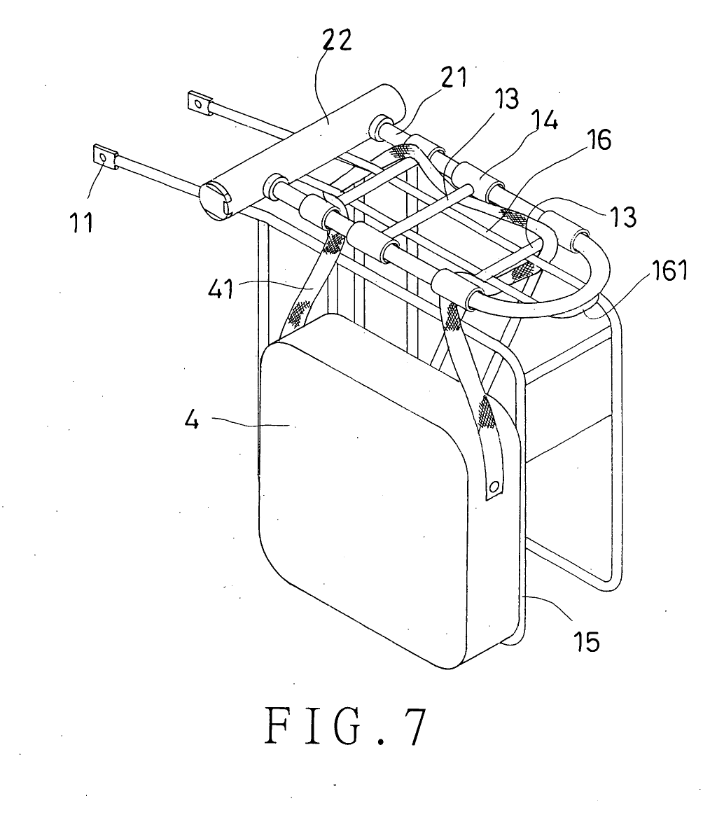

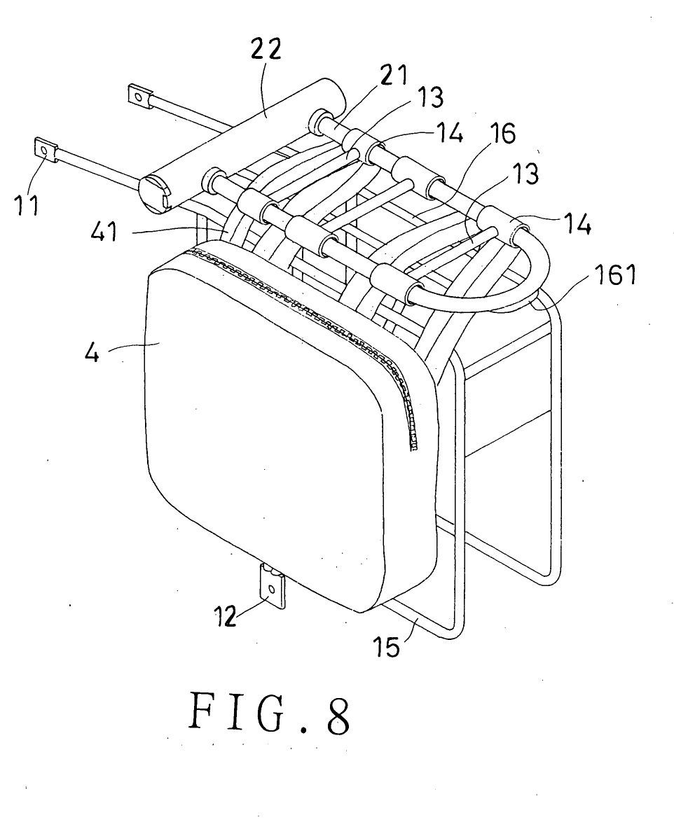

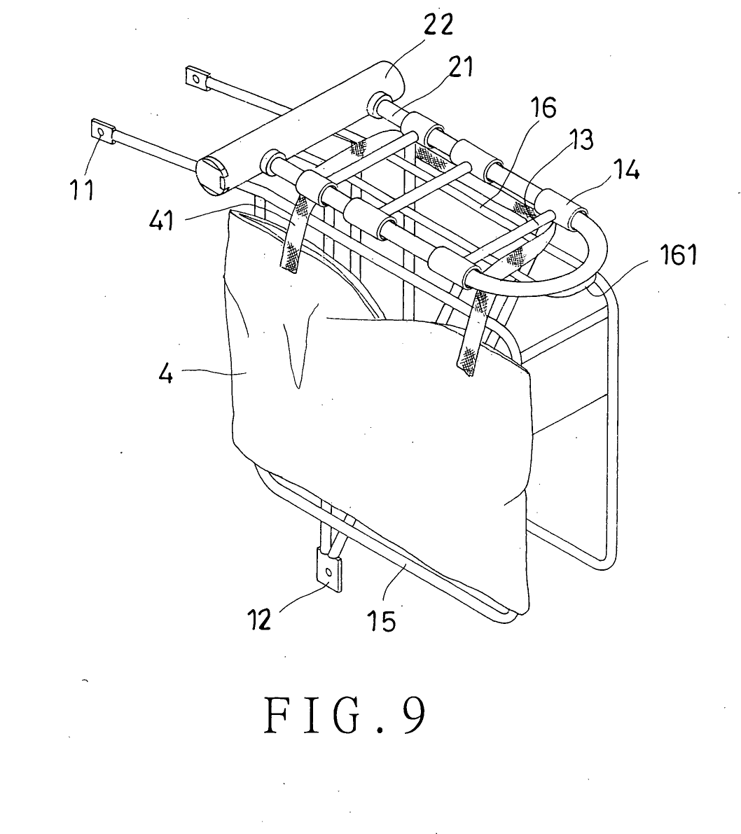

FIGS. 6 to 9 show a way to use the carrier of the present invention to support a large-sized bag 4 with relatively long shoulder straps 41; the shoulder straps 41 are passed over the hooked hanging parts 13 on two sides of the supporting member 1; thus, the length of the shoulder straps 41 is reduced. Next, the U-shaped locking rod 21 of the lock 2 is passed through the tubular holding parts 14, and the lock body 22 is fixedly joined on two free ends of the locking rod 21.

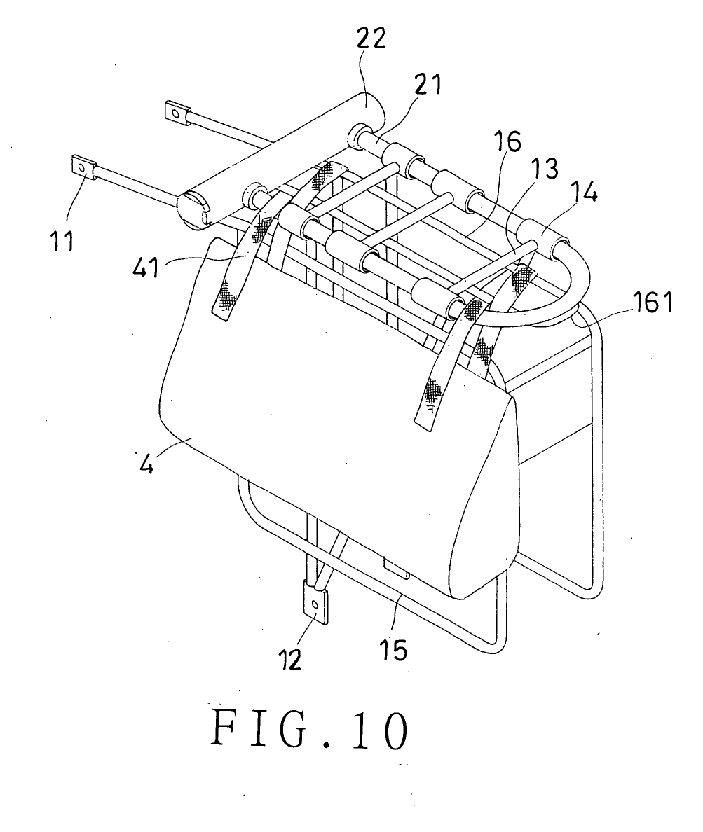

FIG. 10 shows another way to use the carrier to support a bag, which can be one 3 with short carry handles 31 or a large-sized one 4 with relatively long shoulder straps 41; the carry handles 31/shoulder straps 41 of the bag are passed over the hanging parts 161 on the front and the rear ends of the propping component 16. Next, the U-shaped locking rod 21 of the lock 2 is passed through the tubular holding parts 14, and the lock body 22 is fixedly joined on two free ends of the locking rod 21.

When a bag is hung next to one lateral side of the supporting member 1, the bag will be propped against an outward side of the corresponding stopping part 15; thus, a rear wheel of the two-wheeled vehicle is prevented from getting entangled with the body and the carry handles of the bag. And, when a bag is positioned on an upper side of the propping component 16, a rear wheel of the two-wheeled vehicle can be prevented from getting into contact with the bag owing to the propping component 16. Therefore, the present invention is relatively safe to use. Furthermore, after the U-shaped locking rod 21 of the lock 2 is passed through the tubular holding parts 14 of the supporting member 1, and fixedly joined to the lock body 22, the lock 2 will be propped on the hanging parts 161 on the front and the rear ends of the propping component 16; thus, the lock 2 is very steady, and cannot shake or hit against the supporting member 1 to produce noise.

From the above description, it can be seen that the present invention has the following advantages over the prior art:

1. The supporting member of the present invention has several hooked hanging parts on each of two lateral sides of an upper end, and each of the hooked hanging parts has a tubular holding part joined on an outward end. Therefore, a bag with short carry handles, e.g. briefcase, and carry-on bag, can be hung on the hooked hanging parts at the carry handles, and protected against theft by means of making the U-shaped locking rod passed through the tubular holding parts and fixedly fastened to the body of the lock.

2. The supporting member of the present invention has a propping component, which is under the hooked hanging parts, and which has two hanging parts respectively protruding from front and rear ends thereof. Therefore, a bag with carry handles can be hung on the hanging parts of the propping component, and protected against theft by means of making the U-shaped locking rod passed through the tubular holding parts and fixedly fastened to the body of the lock.

3. The propping component of the supporting member of the present invention has front and rear hanging parts to hang bags on while the prior carrier and lock combination has to be equipped with hard inner and outer half tubes to support the handles of the saddle-like bags and hard outer pipes of the rectangular bags as described in Background. Therefore, the present invention has a relatively simple structure, and low manufacturing cost as compared with the prior art.

4. The supporting member of the present invention has a propping component, which is under the hooked hanging parts, and which has two hanging parts respectively protruding from front and rear ends. Therefore, after the U-shaped locking rod of the lock is passed through the tubular holding parts of the supporting member, and fixedly joined to the lock body, the lock will be propped on the hanging parts on the front and the rear ends of the propping component; thus, the lock is very steady, incapable of shaking or hitting against the supporting member to produce noise.

What is claimed is:

1. Structure of a removable carrier of a two-wheeled vehicle with stealth-proof function, comprising
a supporting member having two front joining components protruding from a front end thereof; the front joining components being fixedly joined on a body of a two-wheeled vehicle; the supporting member having two lower joining components protruding from lower ends of two lateral sides thereof; the lower joining components being fixedly joined on a rear axle of the two-wheeled vehicle; the supporting member having a plurality of hooked hanging parts on each of two lateral sides of an upper end thereof; each of the hooked hanging parts having a tubular holding part joined on an outward end thereof; the supporting member having a propping component on an upper portion thereof, which is under the hooked hanging parts; the propping component of the supporting member having two hanging parts respectively protruding from front and rear ends thereof; and
a lock including a lock body, and an U-shaped locking rod; the lock being joined on the supporting member with the U-shaped locking rod being passed through the tubular holding parts of the supporting member and fixedly joined to the lock body.

2. The removable carrier structure of a two-wheeled vehicle with stealth-proof function as claimed in claim 1, wherein the supporting member has a stopping part on each of two lateral sides thereof; the lower joining components existing between both of the stopping parts.
